(19) United States
(12) Patent Application Publication
(10) Pub. No.: US 2025/0360844 A1
(43) Pub. Date: Nov. 27, 2025

(54) LONGITUDINAL ADJUSTMENT DEVICE AND VEHICLE SEAT

(71) Applicant: Adient US LLC, Plymouth, MI (US)

(72) Inventors: Ingo QUAST, Düsseldorf (DE); Erik SPRENGER, Wermelskirchen (DE)

(21) Appl. No.: 19/209,900

(22) Filed: May 16, 2025

(30) Foreign Application Priority Data
May 21, 2024 (DE) 10 2024 204 682.5

(51) Int. Cl. B60N 2/06; B60N 2/02

(52) U.S. Cl. CPC B60N 2/067; B60N 2/02253

(57) ABSTRACT

A longitudinal adjustment device may have one rail arrangement and one drive device for the rail arrangement. The rail arrangement may have a first rail, and a second rail guided movably on the first rail. The drive device may have at least one motor, a gear unit supported in the second rail, a spindle with a spindle thread, and a spindle bearing. The gear unit may have a drive worm drivable by the motor, and a worm wheel, which is in operative connection with the worm teeth. The drive worm and the worm wheel are supported in a gear housing. The worm wheel is supported in the gear housing in an axially resilient manner and in the axial direction, on the one hand via an axial ball bearing and on the other hand via an axial bearing bush.

### FIELD

The invention relates to a longitudinal adjustment device (also referred to for short as a longitudinal adjuster), in particular a motor vehicle seat. The invention also relates to a vehicle seat.

### BACKGROUND

DE 10 2017 218 492 A1 discloses a longitudinal adjuster, in particular for a vehicle seat. The longitudinal adjuster has at least one rail arrangement, which is formed from a first rail and a second rail, which is movable in the longitudinal direction relative to the first rail, wherein the rails engage around each other to form an inner channel. A spindle nut supported by means of the second rail, and a spindle operatively connected to the spindle nut, are arranged in the inner channel, wherein a gear that can be driven by means of a motor and interacts with the spindle is arranged at one end of the first rail. At a front end portion of the spindle, the spindle is supported in the gear and, at a rear end portion of the spindle, it is supported in a rotary bearing of the first rail. WO 2023/062567 A1 discloses a further longitudinal adjuster with a gear unit and a gear wheel that is axially resiliently supported relative to a gear housing.

The problem to be solved by the invention is that of improving a longitudinal adjustment device of the type stated at the outset, in particular of proposing an electrically drivable longitudinal adjustment device having an integrated motor-gear unit, and of providing a corresponding vehicle seat.

### SUMMARY

According to the invention, the first-mentioned problem is solved by means of a longitudinal adjustment device having the features of patent claim 1. According to the invention, the problem mentioned second is solved by means of a vehicle having the features of patent claim 11.

The longitudinal adjustment device according to the invention comprises at least one rail arrangement, and one drive device for the rail arrangement, wherein the rail arrangement comprises a first rail, and a second rail guided movably on the first rail, wherein the drive device comprises at least one motor, a gear unit supported in the second rail, a spindle with a spindle thread, and a spindle bearing, wherein the gear unit comprises a drive worm drivable by the motor, and a worm wheel, which is in operative connection, in particular in mesh, with the drive worm, and a spindle nut, which is in operative connection with, in particular coupled rotationally to, the worm wheel, wherein the spindle is of fixed design, is supported in the spindle bearing and is connected to the first rail, wherein the drive worm, the worm wheel (also referred to as a spiral gear or gearwheel) and the spindle nut are supported in a gear housing, and wherein the worm wheel and/or the spindle nut are/is supported, in particular rotatably supported, in the gear housing in an axially resilient manner and in the axial direction, on the one hand via at least one axial ball bearing and on the other hand via an axial bearing bush.

Alternatively, two axial ball bearings can be provided. The axial ball bearings can, for example, be located on both sides of the worm wheel (also called worm gear) and/or the spindle nut.

Here, the worm wheel can, for example, be operatively connected to the spindle nut, which is, in turn, in operative connection, in particular in mesh, with the spindle. The worm wheel and the spindle nut can form a single component, for example. Alternatively, the spindle nut can be of separate design, wherein the worm wheel is operatively connected to the spindle nut, in particular coupled in terms of motion or coupled for conjoint rotation.

In other words: the worm wheel can simultaneously form the spindle nut. For example, the worm wheel has external worm teeth and an internal nut thread as a spindle nut.

In particular, the drive worm can have first teeth, in particular worm teeth or a first toothed portion. The worm wheel can, for example, have second teeth, in particular worm wheel teeth or a second toothed portion. The first teeth are designed as external teeth on the drive worm. The second teeth are designed as external teeth on the worm wheel. The first teeth and the second teeth form a gear wheel pair for the drive device.

If the worm wheel and the spindle nut are formed jointly, the worm wheel has a thread on the inside (also referred to as an internal nut thread), in particular a trapezoidal thread, which is in engagement with an external spindle thread of the spindle. When the drive worm is driven by means of the motor, the drive worm and the worm wheel driven by means of the drive worm and, necessarily, the spindle nut, rotate. The positioning of the worm wheel designed simultaneously as a spindle nut is accomplished by means of a radial bearing assembly, in particular by means of at least one radial bearing bush. In addition, the worm wheel can be supported on the fixed spindle, which is mounted non-rotatably in the vehicle. On account of the rotary motion of the worm wheel and, necessarily, of the spindle nut, the spindle nut and thus the worm wheel move along the longitudinal axis (also referred to as the spindle axis) of the spindle. A longitudinal adjustment along the longitudinal axis of the fixed spindle is thereby brought about in a simple manner.

In particular, the drive worm is rotatable about a first axis, e.g. a drive axis or a first gear axis. The worm wheel meshing with the drive worm is, in particular, rotatable about a second axis, e.g. an output axis or a second gear axis. In particular, the first axis extends perpendicularly to the second axis.

By virtue of the fact that the worm wheel and/or the spindle nut are/is supported in an axially resilient manner, a particularly efficient rail drive (drive device for the rail arrangement) with low frictional losses is made possible. For example, the worm wheel and/or the spindle nut can be supported in the gear housing in an axially resilient manner and/or in such a way as to compensate for axial tolerances by means of a combined bearing consisting of the at least one sprung axial ball bearing (a combination of a spring washer and an axial ball bearing), e.g. two axial ball bearings in combination with two spring washers, and an axial bearing bush, in particular an axial sliding bearing.

The axial ball bearing is understood, in particular, to mean a ball cage ring with balls. Conventional annular washers, between which the ball cage ring is usually arranged, are eliminated. The axial ball bearing and thus the ball cage ring are preferably arranged directly between the worm wheel/the spindle nut and the spring washer.

Advantageous embodiments, which can be used individually or in combination with one another, form the subject matter of the dependent claims.

As an axial ball bearing, it is also possible, for example, to use a standard axial ball bearing. For the spring action to bring about freedom from play, the axial bearing bush with the integrated spring element can be provided instead of the spring washer opposite the axial ball bearing or standard axial ball bearing.

For example, the spring washer can be arranged between the gear housing and the axial ball bearing in the axial direction. In the axial direction, the spring washer can on the one hand rest against the gear housing and on the other hand make contact with a contact surface on the axial ball bearing, for example.

The axial ball bearing can be arranged between the spring washer and the worm wheel and/or the spindle nut in the axial direction, for example. In the axial direction, the axial ball bearing can on the one hand make contact with the spring washer and on the other hand make contact with a race surface on the worm wheel and/or on the spindle nut, for example.

In addition, the axial bearing bush can be designed as an angle bearing bush, for example. The axial bearing bush can have, for example, a cylindrical radial bearing portion, in particular a radial sliding bearing, and, adjoining said portion, an axial bearing portion in the form of an annular disk. The axial bearing portion can be designed, for example, as a radially inward-pointing axial annular collar, in particular an axial sliding collar bearing.

In addition, it is possible, for example, for a radial bearing bush to be provided on an end region of the worm wheel and/or of the spindle nut which faces the axial ball bearing. The radial bearing bush can be designed as a hollow-cylindrical radial sliding bearing, for example. In this case, the radial bearing bush can have a radially projecting portion for rotationally secure support in the gear housing, for example. In other words: on the inside, the radial bearing bush comprises a sliding bearing for the worm wheel and/or the spindle nut and, on the outside, it comprises an anti-rotation safeguard for non-rotatable support of the radial bearing bush in the gear housing.

In addition, the axial bearing bush can have a radially projecting portion for rotationally secure support in the gear housing, for example. In other words: on the inside and at the end, the axial bearing bush comprises in each case a sliding bearing for the worm wheel and/or the spindle nut and, on the outside, it comprises an anti-rotation safeguard for non-rotatable support of the axial bearing bush in the gear housing.

In the region of the drive screw, both the radial bearing bush and the axial bearing bush can have an outward-directed narrowing region for ensuring play or a gap between the drive worm and the radial bearing bush and the axial bearing bush. The respective narrowing region is a radially decreasing region which ends with a tapered portion which faces in the axial direction in the direction of the drive screw.

The worm wheel teeth of the worm wheel and/or the spindle nut can furthermore project radially beyond cylindrical nut portions. The cylindrical nut portions are designed, in particular, as sliding portions, e.g. sliding surfaces, for support in the radial bearing bush and/or in the axial bearing bush.

The problem is furthermore solved according to the invention by a vehicle seat having the longitudinal adjustment device described above.

In addition, another longitudinal adjustment device which is of the same construction or is identical and has an identical rail arrangement with an identical drive device, in particular a direct drive, can be provided, wherein an unwanted non-synchronous adjustment of the second rail of one rail arrangement of one longitudinal adjustment device with respect to the second rail of the other rail arrangement of the other longitudinal adjustment device can be partially compensated at least by means of the axial play.

In another alternative, it is also possible, in order to avoid an unwanted nonsynchronous adjustment, to provide for one drive device to guide one of the second rails under control in terms of rotation rate, in particular under speed control and/or position control, and for the other second rail to have end stops, which have a larger spacing than end stops of the leading second rail. In this way, it is possible, for example, to ensure that only the leading second rail, in particular the controlled second rail, travels to its end stops or strikes against the latter and that the vehicle seat does not rotate about its vertical axis when it reaches the stop position against the end stop, even if the other second rail travels in the lead or lags behind.

The advantages achieved by means of the invention consist, in particular, in that worm wheel support and/or spindle nut support that is highly efficient, in particular low-friction, or compensates for different adjusting movements, at least in some region or regions, is made possible by means of the spindle bearing with axial play and/or by means of the configuration of the end stops, in particular of the shorter distance of the leading rail from the associated end stops in comparison with the larger distance of the following or trailing rail from its end stops. The combination of axial play and end stops enables an optimum adjusting function with a high degree of comfort.

### DESCRIPTION OF THE FIGURES

The invention is explained in greater detail below with reference to advantageous exemplary embodiments illustrated in the figures. However, the invention is not restricted to these exemplary embodiments. Of the figures:

FIG. 1: shows, in a schematic illustration, a vehicle seat having a longitudinal adjustment device (also referred to as a longitudinal adjuster),

FIG. 2: shows a plan view of a rail arrangement with a drive device of a longitudinal adjustment device according to the invention,

FIG. 3: shows a perspective view of the rail arrangement with the drive device of the longitudinal adjustment device according to the invention,

FIG. 4: shows a perspective view of the rail arrangement with the drive device according to FIG. 3 without the top rail,

FIG. 5: shows a perspective view of the drive device according to FIG. 3 without the rail arrangement,

FIG. 6: shows a section through a gear unit of the drive device along the line VI in FIG. 5,

FIG. 7: shows an enlarged partial view of the section shown in FIG. 6 in the contact region between the axial ball bearing and the spring washer,

FIG. 8: shows another section through the drive device and the gear unit,

FIG. 9: shows a perspective illustration of the drive device and of the gear unit with the holding clamp,

FIG. 10: shows a perspective view of the drive device and of the gear unit without the holding clamp,

FIG. 11: shows a perspective section through the drive device and the gear unit without the holding clamp,

FIG. 12: shows a perspective illustration of the drive device and of the gear unit without the holding clamp and without the gear housing,

FIG. 13: shows a perspective illustration of the drive device and of the gear unit with the spindle,

FIG. 14: shows a perspective illustration of a worm wheel with a spindle nut having a groove-shaped race for an axial ball bearing, and

FIG. 15: shows a cut-open view of a gear housing of a gear unit.

In all the figures, mutually corresponding parts are provided with the same reference signs.

### DETAILED DESCRIPTION

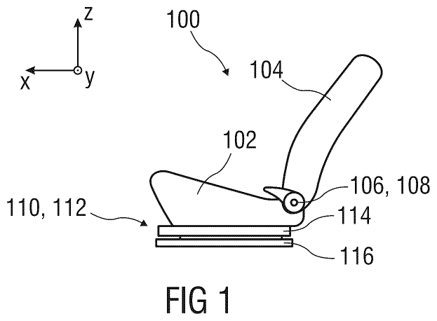

A vehicle seat 100 illustrated schematically in FIG. 1, which relates to the prior art, is described below using three spatial directions perpendicular to one another. In the case of a vehicle seat 100 installed in the vehicle, a longitudinal direction x runs largely horizontally and preferably parallel to a vehicle longitudinal direction, which corresponds to the normal driving direction of the vehicle. A transverse direction y, which runs perpendicularly to the longitudinal direction x, is likewise aligned horizontally in the vehicle and runs parallel to a vehicle transverse direction. A vertical direction z runs perpendicularly to the longitudinal direction x and perpendicularly to the transverse direction y. With a vehicle seat 100 installed in the vehicle, the vertical direction z preferably runs parallel to a vehicle vertical axis.

The position indications and direction indications used, such as front, rear, top and bottom, refer to a direction of view of an occupant sitting in a normal sitting position in the vehicle seat 100, wherein the vehicle seat 100 is installed in the vehicle, in a use position suitable for carrying people, with the seat back 104 upright, and is oriented in the usual manner in the direction of travel. However, the vehicle seat 100 can also be installed or moved in a different orientation, e.g. transversely to the direction of travel. Unless otherwise described, the vehicle seat 100 is constructed in mirror symmetry with respect to a plane running perpendicularly to the transverse direction y.

The seat back 104 can be arranged pivotably on a seat part 102 of the vehicle seat 100. For this purpose, the vehicle seat 100 can optionally comprise a fitting 106, in particular an adjustment fitting, rotation fitting, latching fitting or tilt fitting.

The position indications and direction indications used, such as radial, axial and in the circumferential direction, refer to an axis of rotation 108 of the fitting 106. Radial means perpendicular to the axis of rotation 108. Axial means in the direction of or parallel to the axis of rotation 108.

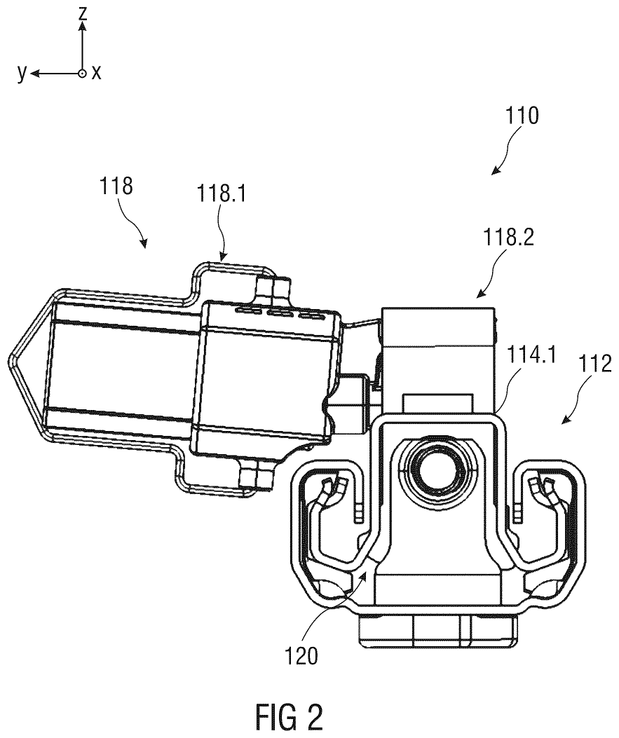

The vehicle seat 100 can optionally comprise a longitudinal adjustment device 110. The longitudinal adjustment device 110 comprises, for example, a rail arrangement 112 (also referred to as a rail pair) having a first rail element 114 and a second rail element 116. The first rail element 114 is adjustable relative to the second rail element 116 in the longitudinal direction x. The first rail element 114 is secured on the seat part 102. The second rail element 116 is secured on a structural element of a vehicle, e.g. a vehicle floor. For each vehicle seat 100, the longitudinal adjustment device 110 can comprise two rail arrangements 112, which can be adjusted synchronously by means of a drive device 118 (illustrated in FIG. 2). As an alternative, each rail arrangement 112 can comprise an associated drive device 118. If the vehicle seat 100 is designed as a bench seat with a plurality of seating surfaces, more than two rail arrangements 112, e.g. three, four, five or six rail arrangements 112, can be provided. The rail arrangements 112 are arranged parallel to one another and can be adjusted synchronously by means of one drive device 118 or a plurality of drive devices 118.

The top rails 114 (also referred to as seat rails) are connected to the vehicle seat 100 for the adjustment of the latter. The longitudinal adjustment device 110, in particular the rail arrangements 112 thereof, can be adjusted in synchronism with one another via flexible shafts, in particular by electric motor. Like the vehicle seat 100, the rail arrangements 112 are aligned in the direction of travel or longitudinal direction x.

For greater clarity, the first rail element 114 is referred to as the top rail 114 in the following description. This top rail 114 (also referred to as a running rail) is assigned to the vehicle seat 100 and configured to support this vehicle seat 100. The second rail element 116 is referred to below as the bottom rail 116. The bottom rail 116 is connected in a fixed manner and by way of example to the floor of a vehicle.

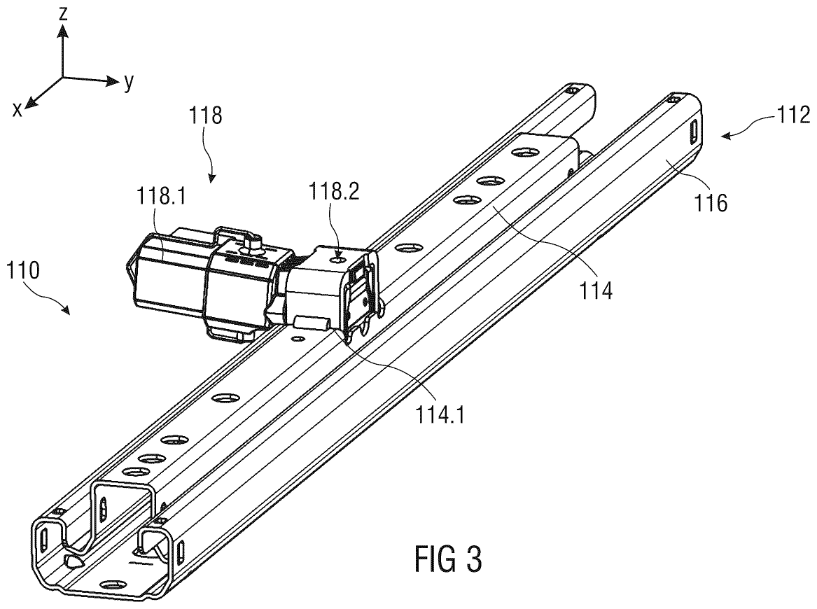

FIG. 2 shows a plan view of the rail arrangement 112 with a drive device 118 of the longitudinal adjustment device 110 according to the invention. FIG. 3 shows a perspective view of the rail arrangement 112 with the drive device 118 of the longitudinal adjustment device 110.

The rail arrangement 112 has the drive device 118 for adjustment of the top rail 114 relative to the bottom rail 116. The drive device 118 has at least one motor 118.1 and one gear unit 118.2. The drive device 118 is designed as a direct drive.

The gear unit 118.2 is arranged at least partially in a cavity 120 formed between the top rail 114 and the bottom rail 116 (illustrated in FIG. 2).

The motor 118.1 is arranged perpendicularly to the longitudinal direction x and coupled to the gear unit 118.2. The motor 118.1 can be arranged below the seat part 102 (illustrated in FIG. 1) by means of a motor holder (not illustrated). The motor 118.1 can, for example, be directly coupled to the top rail 114 and held by means of a motor holder, in particular a plastic holder.

The gear unit 118.2 projects at least partially through a rail aperture 114.1 in the top rail 114, projecting upward in the vertical direction z from it or through it.

In the present case, the motor 118.1 and the gear unit 118.2 are attached jointly to the rail arrangement 112, in particular centrally over the length of the top rail 114. In particular, the motor 118.1 and the gear unit 118.2 are attached to the top rail 114 and can be moved along with the latter during a longitudinal adjustment.

Thus, at least the motor 118.1 is easy to exchange or repair in the installed state.

The gear unit 118.2 can be connected to the top rail 114, in particular by force-locking and/or form-locking, e.g. by screw fastening, or materially, e.g. being secured by means of a welded seam, and/or by form-locking, e.g. being press-locked, to enable it to transmit high forces.

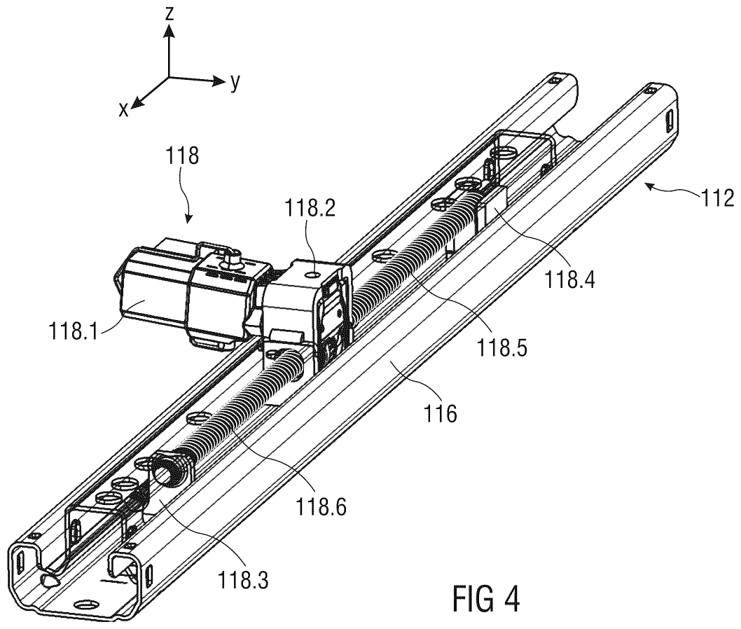

In the case of force-locking and form-locking coupling, for example, it is possible to provide elastic inserts, e.g. rubber shims, which hold the gear unit 118.2 (also referred to for short as a gear) in position, in a rattle-free manner and under prestress, at the appropriate holding angle on the top rail 114 by means of the compression-loaded elastic inserts, e.g. rubber mounts. The force-locking nevertheless allows a vertical compensating movement of the gear unit 118.2 (and of the motor 118.1 coupled to the gear) in the vertical direction z (also referred to as the z direction) if there is a need to compensate for height tolerances of the spindle 118.5 (illustrated in FIG. 4) and the top rail 114.

FIG. 4 shows a perspective view of the rail arrangement 112 with the drive device 118 according to FIG. 3 and with the bottom rail 116 and without the top rail 114 of the rail arrangement 112, as shown in FIG. 3.

The drive device 118 is designed as a spindle drive, for example. The drive device 118 comprises at least the motor 118.1, the gear unit 118.2, two spindle bearings 118.3, 118.4 fixed with respect to the bottom rail 116 (also referred to as a floor rail), and a spindle 118.5, which has a spindle thread 118.6.

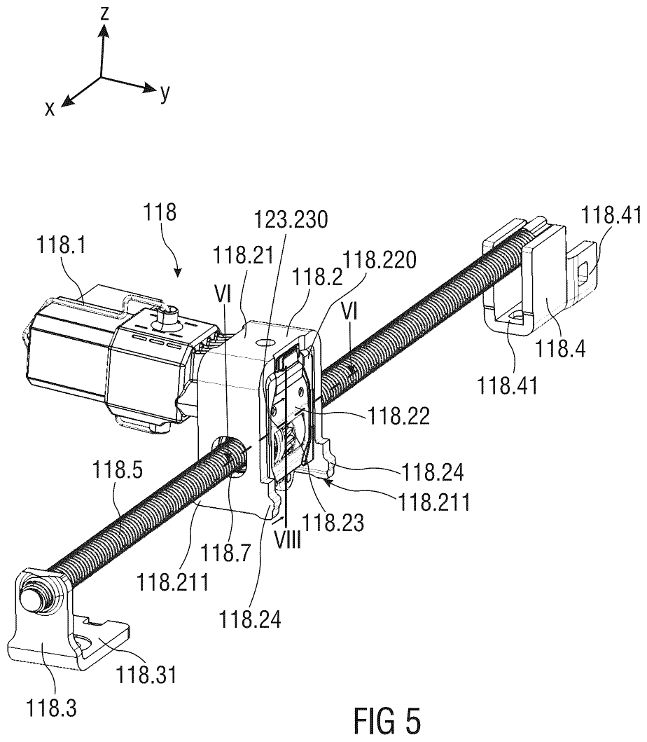

FIG. 5 shows a perspective view of the drive device 118 according to FIG. 3 without the rail arrangement 112 and thus without the top rail 114 and without the bottom rail 116 (as shown in FIG. 3).

The spindle 118.5 is of fixed design, is supported in the spindle bearings 118.3, 118.4 and is firmly connected to the bottom rail 116 via said bearings. For example, it is possible, on the one hand, for the spindle 118.5 to be firmly connected materially, in particular by means of a welded joint, to one of the spindle bearings 118.3, 118.4 and, on the other hand, by form-locking and force-locking, e.g. by means of a threaded joint, to the other of the spindle bearings 118.3, 118.4. In other words: the spindle 118.5 is held in and firmly connected to the spindle bearings 118.3, 118.4 in various ways. It is thereby possible to optimize an installation sequence.

A first spindle bearing 118.3 can be designed as an L profile, for example. A second spindle bearing 118.4 can be designed as a U profile or as a bearing pedestal, for example. The spindle bearings 118.3, 118.4 support the free spindle ends of the spindle 118.5 and are firmly connectable or connected in various ways to the bottom rail 116 via associated fastening lugs 118.31 or fastening surfaces 118.41, as described by way of example above.

The gear unit 118.2 (illustrated in FIG. 4) comprises a gear holder 118.21, in particular a U-shaped holding clamp, by means of which the gear unit 118.2 is held by form-locking and/or force-locking in the top rail 114. At free clamp ends 118.211, the gear holder 118.21 has outer latching noses 118.24, for example, for fastening the gear unit 118.2 on the adjustable top rail 114. These free clamp ends 118.211 can, for example, lie within a hole pattern of the top rail 114 and can in part be connected materially to the top rail 114, e.g. by means of a welded joint. Alternatively, these may also be connected to one another without material bonding and may absorb high longitudinal forces (particularly in a crash) since the latching noses 118.24 are locked within the laterally associated hole pattern and are thus connected by form-locking.

The gear holder 118.21 is configured to receive and hold a gear housing 118.22. A worm wheel 118.23 and a spindle nut 118.230 are rotatably supported in the gear housing 118.22, wherein the spindle nut 123.230 is in engagement with the spindle 118.5. For example, the gear housing 118.22 can be held in the gear holder 118.21 while being braced by means of elastic inserts (not illustrated specifically, e.g. by means of rubber mounts).

In this case, the spindle 118.5 is supported in a fixed manner by through openings 118.7 (also referred to as spindle openings) in the gear holder 118.21. In the gear housing 118.22, the spindle nut 123.230 runs on the spindle 118.5.

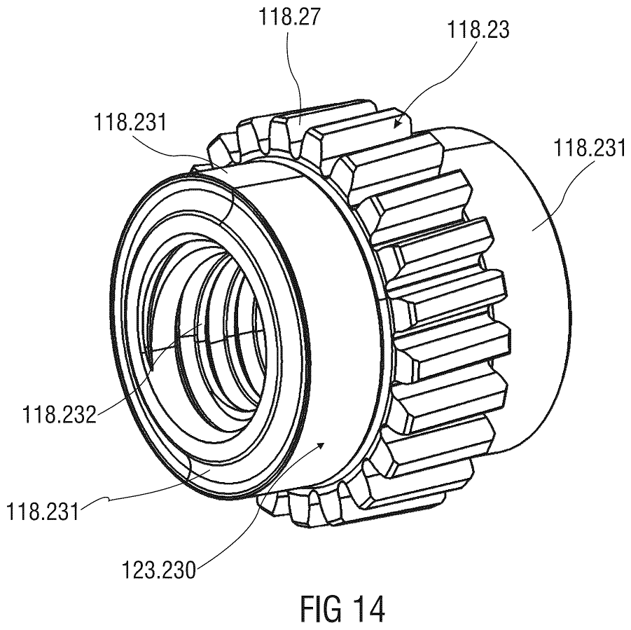

Here, the worm wheel 118.23 can, for example, be operatively connected to the spindle nut 123.230, which is, in turn, in operative connection, in particular in mesh, with the spindle 118.5. The worm wheel 118.23 and the spindle nut 123.230 (as shown in FIG. 14) can form a single component, for example. Alternatively, the spindle nut 123.230 can be of separate design, wherein the worm wheel 118.23 can be operatively connected to the spindle nut 123.230, in particular coupled in terms of motion or coupled for conjoint rotation.

In this case, the worm wheel 118.23 and/or the spindle nut 123.230 can be held by force-locking and in position in the top rail 114 (illustrated in FIG. 3) via the gear housing 118.22.

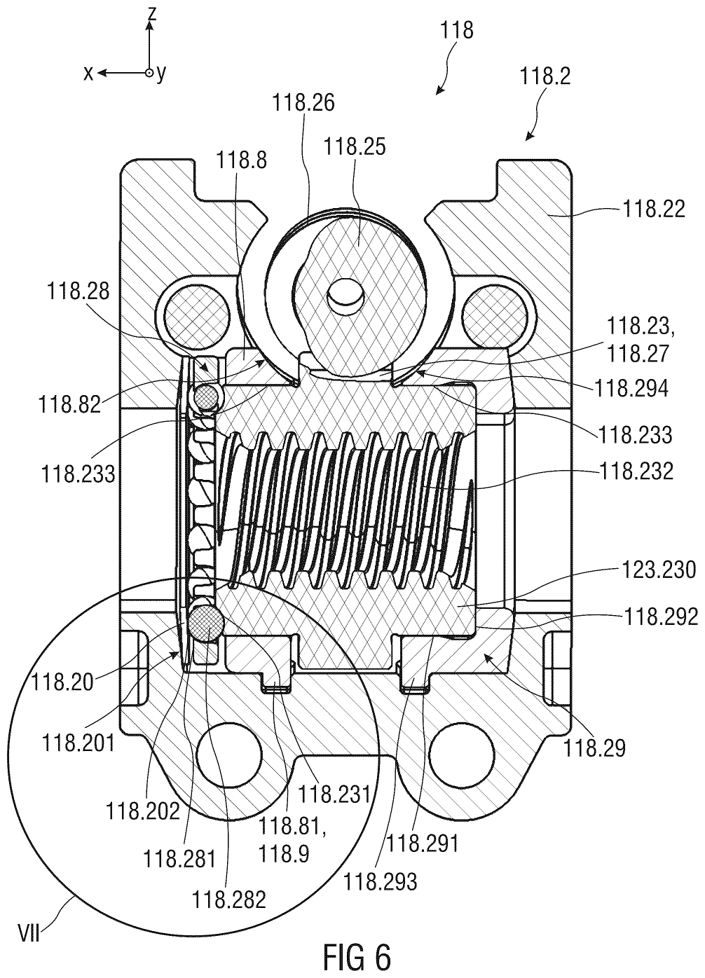

FIG. 6 shows a section through the gear unit 118.2 of the drive device 118 along the line VI in FIG. 5.

The drive device 118 can, for example, comprise the fixed spindle 118.5 (illustrated in FIG. 5), in particular the spindle 118.5 supported in a fixed manner on the bottom rail (116 (illustrated in detail in FIGS. 3 and 4).

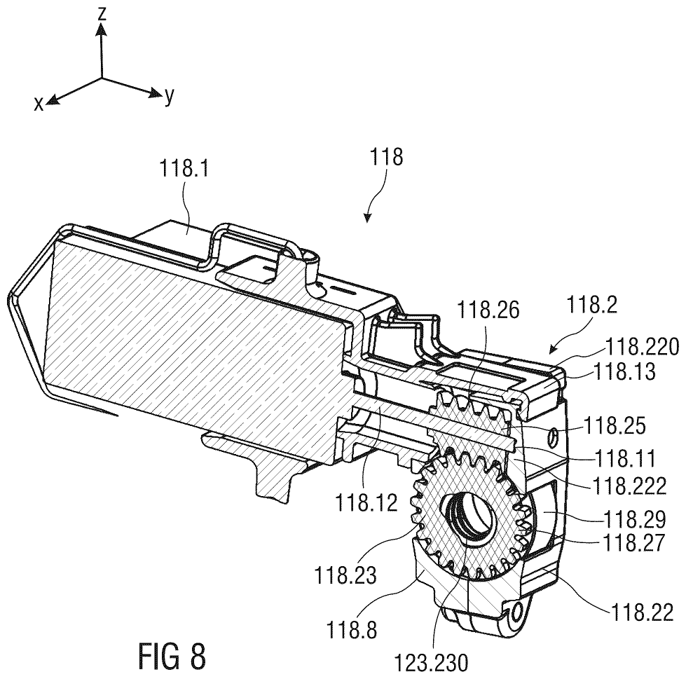

The gear unit 118.2 supported in the top rail 114 (illustrated in FIG. 3) can be designed as a worm wheel gear. The gear unit 118.2 can comprise, for example, a drive worm 118.25 that can be driven by the motor 118.1 and has worm teeth 118.26 (also illustrated in FIG. 8), and the worm wheel 118.23, which has worm wheel teeth 118.27 and is in operative connection, in particular in mesh, with the worm teeth 118.26.

The drive worm 118.25, the worm wheel 118.23 and the spindle nut 123.230 are supported in the gear housing 118.22. In the case of one-piece design of the worm wheel 118.23 and the spindle nut 123.230, the worm wheel teeth 118.27 (also referred to as external worm wheel teeth) in mesh with the drive worm 118.25 are provided on the outside of the spindle nut 123.230.

The worm wheel 118.23 and/or the spindle nut 123.230 are/is supported, in particular rotatably supported, in the gear housing 118.22 in an axially resilient manner and in an axial direction, in particular in the longitudinal direction x, on the one hand via an axial ball bearing 118.28 and on the other hand via an axial bearing bush 118.29.

The gear unit 118.2 is used to transmit the rotary motion provided by the motor 118.1 (illustrated in FIG. 5), in particular by an ultracompact motor, via the worm teeth 118.26 of the drive worm 118.25 and the worm wheel teeth 118.27 of the worm wheel 118.23, to the spindle nut 123.230 in engagement with the spindle 118.5 via a trapezoidal thread 118.232. This converts the rotary motion of the drive worm 118.25 and of the worm wheel 118.23 into a linear motion of the spindle nut 123.230 along the spindle 118.5. In this case, the linear motion of the spindle nut 123.230 is transmitted via the gear housing 118.22 to the top rail 114 and, via the latter, to the seat part 102 (illustrated in FIG. 1). Consequently, the top rail 114 and the seat part 102 fastened to the latter are moved in linear fashion relative to the bottom rail 116 along the fixed spindle 118.5.

In this case, the worm wheel 118.23 is supported on one side, in particular supported in an axially resilient manner, directly or via the spindle nut 123.230, via the at least one sprung axial ball bearing 118.28, in particular a combination of the axial ball bearing 118.28 and a spring washer 118.20, relative to the gear housing 118.22. In the exemplary embodiment shown, the worm wheel 118.23 has a nut portion (also referred to as spindle nut 123.230) with an internal trapezoidal thread 118.232, which is in engagement with the spindle 118.5 (illustrated in FIG. 4 or 5).

Axial freedom from play is achieved by means of the spring force of the spring washer 118.20 situated between the axial ball bearing 118.28 (also referred to as a ball bearing ring) and the gear housing 118.22.

By virtue of the fact that the worm wheel 118.23 and the integrated spindle nut 123.230 are supported in an axially resilient manner, a particularly efficient rail drive (=drive device 118 for the radial arrangement 112) with low frictional losses is made possible inasmuch as it is principally the axial ball bearing 118.28 that bears the load.

This is made possible in front seats because these are generally provided with a rail slope. In this way, it is possible to ensure that the main load is always dissipated via the axial ball bearing 118.28 into the top rail 114.

If loads are expected in both directions, in particular in the longitudinal direction x, it is also possible to operate with two axial ball bearings 118.28 since otherwise the sliding friction of the variant with just one axial ball bearing 118.28 and one bearing bush, in particular one axial bearing bush 118.29, would lead to poorer efficiency.

In the case, that two axial ball bearings 118.28 are provided the axial ball bearings 118.28 can, for example, be located on both sides of the spindle nut 123.230 (not shown in detail). The axial bearing bush 118.29 are provided accordingly on both sides of the spindle nut 123.230 and configured accordingly, e.g. only as an L-profile. In particular, the axial ball bearing 118.28 and the axial bearing bush 118.29 on left-hand side of the spindle nut 123.230 are arranged and designed accordingly on the right-hand side.

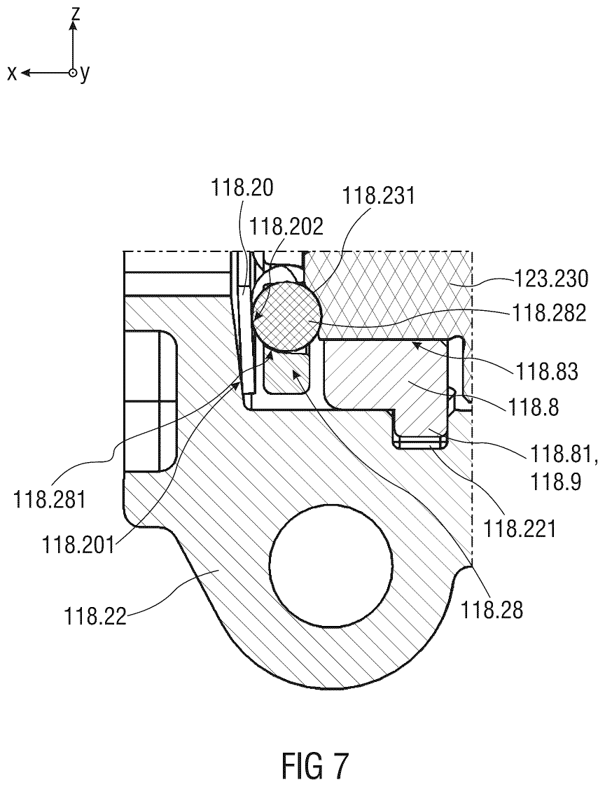

The variant with one axial ball bearing 118.28 represents a particularly low-cost variant of the drive device 118, with the disadvantage of poorer efficiency in the case of loads on the sliding bearing (radial sliding bearing portion 118.83, illustrated in FIG. 7).

For example, the worm wheel 118.23 and the spindle nut 123.230 can be supported in the gear housing 118.22 in an axially resilient manner or in such a way as to compensate for axial tolerances via a combined bearing consisting of the sprung axial ball bearing 118.28 (a combination of spring washer 118.20 and axial ball bearing 118.28) and the axial bearing bush 118.29. The axial bearing bush 118.29 can be designed as an axial sliding bearing and or as a radial sliding bearing, for example.

The worm wheel 118.23 supported in an axially resilient manner and having an integrated spindle nut 123.230 is understood, in particular, to mean a spiral gear with an integrated nut which is elastically preloaded or spring-loaded in the axial direction and is therefore supported in a play-free manner in the gear housing 118.22. In particular, the worm wheel 118.23 with an integrated spindle nut 123.230 is supported elastically against the gear housing 118.22 in the axial direction.

For this purpose, the spring washer 118.20 can be provided in the region of the axial ball bearing 118.28. As an alternative or in addition, the axial bearing bush 118.29 can comprise an integrated spring element in the region of said bush.

For example, the spring washer 118.20 can be arranged between the gear housing 118.22 and the axial ball bearing 118.28 in the axial direction. In the axial direction, it is possible, on the one hand, for the spring washer 118.20 to rest against the gear housing 118.22 with an external contact 118.201 and, on the other hand, for a spring contact surface 118.281 to make contact with the axial ball bearing 118.28 and thus to have an internal contact 118.202 with balls 118.282 of the axial ball bearing 118.28, for example. The lever arm between these contact regions and a free space between the gear housing 118.22 and the spring washer 118.20 behind the internal contact 118.202 (=ball contact) allows spring deflection within the scope of a required axial tolerance compensation.

The axial ball bearing 118.28 can be arranged between the spring washer 118.20 and the spindle nut 123.230 in the axial direction, for example. In the axial direction, it is possible, for example, for the axial ball bearing 118.28 on the one hand to make contact with the spring washer 118.20 at the internal contact 118.202 thereof and, on the other hand, to roll on the spindle nut 123.230 in a race surface 118.231. In this case, the race surface 118.231 can be designed as an annular track surface, for example, in particular as an annular groove, in an end face, facing the axial ball bearing 118.28, of the worm wheel 118.23 with integrated spindle nut 123.230.

As an axial ball bearing 118.28, it is also possible, for example, to use a standard axial ball bearing. For the spring action to bring about freedom from play, the axial bearing bush 118.29 with the integrated spring element (not illustrated specifically) can be provided instead of the spring washer 118.20 opposite the axial ball bearing 118.28 or standard axial ball bearing. A spring plate made of plastic could be integrated, for example. As an alternative, it is also possible, for example, to provide a plastic bearing bush having integrally formed plastic spring elements with an axial force effect as an axial bearing bush 118.29, or else a separate spring washer 118.20.

In addition, the axial bearing bush 118.29 can be designed as an angle bearing bush, for example. The axial bearing bush 118.29 can have, for example, a cylindrical radial bearing portion 118.291, in particular a radial sliding bearing, and, adjoining said portion, an axial bearing portion 118.292 in the form of an annular disk. The axial bearing portion 118.292 can be designed, for example, as a radially inward-pointing axial annular collar, in particular an axial sliding collar bearing.

In addition, it is possible, for example, for a radial bearing bush 118.8 to be provided on an end region of the spindle nut 123.230 which faces the axial ball bearing 118.28. The radial bearing bush 118.8 can be designed as a hollow-cylindrical radial sliding bearing, for example. In this case, the radial bearing bush 118.8 can have a radially projecting portion 118.81 for rotationally secure support of the radial bearing bush 118.8 in the gear housing 118.22, for example. In other words: on the inside, the radial bearing bush 118.8 comprises a sliding bearing for the spindle nut 123.230 and, on the outside, it comprises an anti-rotation safeguard 118.9 for non-rotatable support of the radial bearing bush 118.8 in the gear housing 118.22.

In addition, the axial bearing bush 118.29 can have an additional radially projecting portion 118.293 for rotationally secure support in the gear housing 118.22, for example. In other words: on the inside, in the radial bearing portion 118.291 and at the end in the axial bearing portion 118.292, the axial bearing bush 118.29 comprises in each case a sliding bearing for the worm wheel 118.23 with integrated spindle nut 123.230 and, on the outside, in the radially projecting portion 118.293, it comprises another anti-rotation safeguard 118.9 for non-rotatable support of the axial bearing bush 118.29 in the gear housing 118.22.

In the region of the drive screw 118.25, both the radial bearing bush 118.8 and the axial bearing bush 118.29 can have an associated outward-directed narrowing region 118.82 and 118.294, respectively, for ensuring a gap between the drive worm 118.25 and the radial bearing bush 118.8 and, respectively, between the drive worm 118.25 and the axial bearing bush 118.29. The respective narrowing region 118.82, 118.294 is a radially decreasing region which ends with a tapered portion which faces in the axial direction in the direction of the drive screw 118.25. The contour can also be described by a cylindrical subtraction solid with an axis which is identical with the axis of rotation of the drive worm 118.25.

The worm wheel teeth 118.27 of the spindle nut 123.230 can furthermore project radially beyond cylindrical nut portions 118.233. The cylindrical nut portions 118.233 are designed, in particular, as sliding portions, e.g. sliding surfaces, for support in the radial bearing bush 118.8 and/or in the axial bearing bush 118.29.

FIG. 7 shows an enlarged partial view of the section shown in FIG. 6 in the contact region between the axial ball bearing 118.28 and the spring washer 118.20 with the external contact 118.201 in the direction of the gear housing 118.22 and the internal contact 118.202 in the direction of the axial ball bearing 118.28. The balls 118.282 roll in the race surface 118.231 in the end of the spindle nut 123.230.

On the inside, the radial bearing bush 118.8 comprises a radial sliding bearing portion 118.83 for the spindle nut 123.230 and, on the outside, comprises the anti-rotation safeguard 118.9 with the radially projecting portion 118.81 for non-rotatable support of the radial bearing bush 118.8 in a corresponding housing recess 118.221 in the gear housing 118.22.

FIG. 8 shows another section through the drive device 118 with the motor 118.1 and the gear unit 118.2.

Radially, the worm wheel 118.23 with the integrated spindle nut 123.230 designed as a drive nut and with the worm wheel teeth 118.27 designed as external teeth is held at a suitable distance from the drive screw 118.25 and the worm teeth 118.26 thereof at two points via the radial bearing bush 118.8 and the axial bearing bush 118.29, which are designed as plastic bushes for example.

The opposite end of the worm wheel 118.23 from the axial ball bearing 118.28, with the integrated spindle nut 123.230, is supported via the axial bearing bush 118.29 relative to the gear housing 118.22 (illustrated in FIG. 6). The axial bearing bush 118.29 made of plastic is supported in a manner secure against rotation in the gear housing 118.22, as described above with reference to FIGS. 6 and 7.

The axial ball bearing 118.28 (illustrated in FIG. 6) is arranged within the gear housing 118.22 in such a way that it bears the principal loading in the case of a typical rail slope of a front seat rail. In this case, the spring washer 118.20 (illustrated in FIG. 6) is pushed in in a force-dependent manner and relieves the load on the oppositely arranged axial bearing bush 118.29, in particular a plastic bush, which makes end-face contact.

In special cases, an axial ball bearing 118.28 may also be arranged on both sides of the worm wheel 118.23 and/or of the spindle nut 123.230 in order to obtain higher efficiency in both directions of adjustment and with all possible rail slopes. In both cases (one or two axial ball bearings 118.28), an advantageous, relatively low-power motor 118.1 can be used.

Another increase in efficiency can be achieved by way of a bearing interface 118.11 of a motor shaft 118.12 in the gear housing 118.22. For example, the motor shaft 118.12 can be provided at the end with point support in the gear housing 118.22 in a shaft bearing 118.222. The laterally supported motor shaft 118.12 can have a very small diameter.

The gear housing 118.22 can be produced from a diecast material, in particular from a zinc diecast material, for example. As a result, the gear housing 118.22 has very good bearing properties with low friction. The friction work is thus greatly reduced in the drive stage.

The gear unit 118.2 can be vibrationally decoupled from the top rail 114 by means of rubber elements 118.220.

The motor 118.1 can be connected directly to the gear unit 118.2, in particular the gear housing 118.22, via an adapter 118.13. Thus, vibrations from the motor 118.1 and the gear unit 118.2 are transmitted to the top rail 114 only to a minimal extent. Moreover, the gear unit 118.2 designed as a worm gear is smooth-running by virtue of the principle involved, and this additionally helps to reduce the noise level.

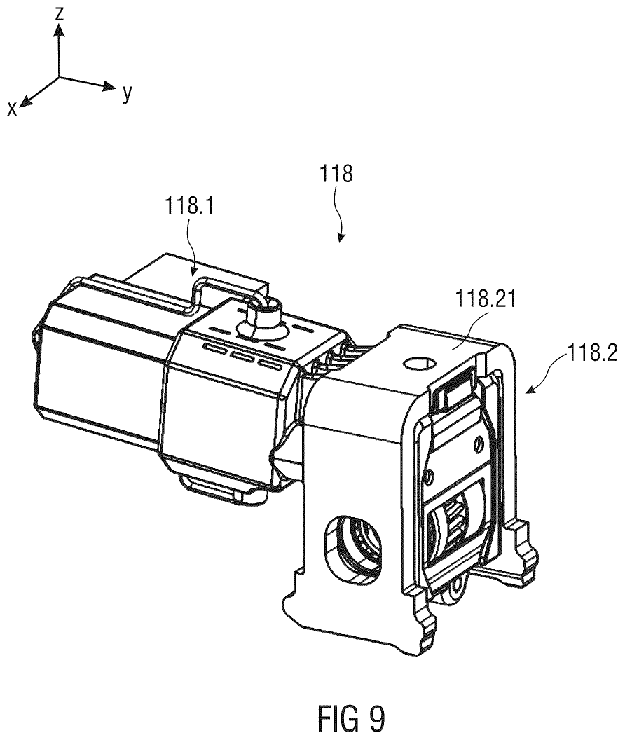

FIG. 9 shows a perspective illustration of the drive device 118 with the motor 118.1 and the gear unit 118.2 with the gear holder 118.21 thereof, designed as a holding clamp, for fastening to the top rail 114 (illustrated in FIG. 2).

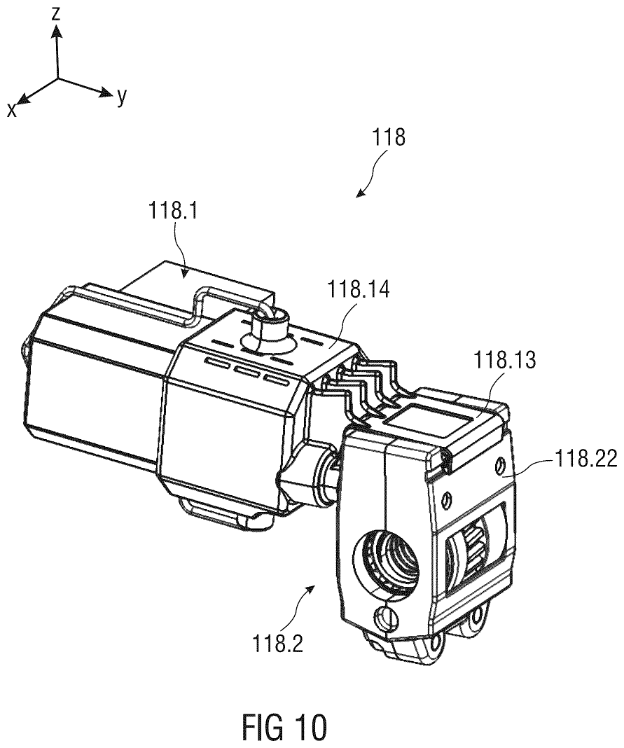

FIG. 10 shows a perspective illustration of the drive device 118 with the motor 118.1 and the gear unit 118.2 without the gear holder 118.21 (illustrated in FIG. 9). The gear housing 118.22 is connected by means of the adapter 118.13 to the motor 118.1, in particular to the motor housing 118.14 thereof.

Another embodiment of the axial motor retention system can be made possible, for example, by means of a wire clip, which is first of all pivoted away sideways and, after the insertion of the motor 118.1 (with the drive worm 118.25 on the drive shaft or motor shaft 118.12), is pivoted into the position shown in FIG. 10. In this case, such a wire clip also enables spring-loaded retention in the axial direction and thus does not allow any play.

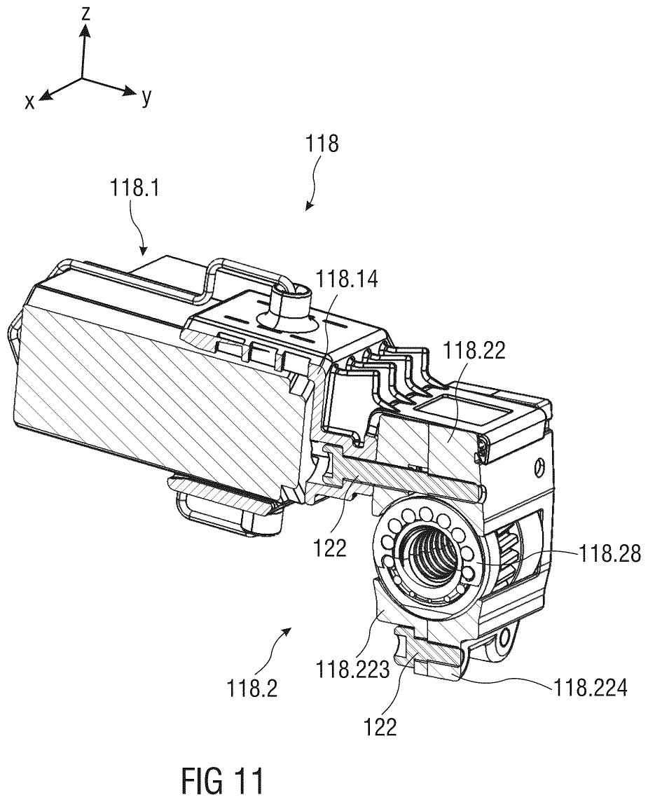

FIG. 11 shows a perspective sectional illustration of the drive device 118 with the motor 118.1 and the gear unit 118.2 without the gear holder 118.21 in the region of the axial ball bearing 118.28. Above the axial ball bearing 118.28, the motor housing 118.14 and the gear housing 118.22 are additionally connected to one another, e.g. by means of a screwed joint involving a fastening screw 122. The gear housing 118.22 is formed from two housing shells 118.223, 118.224, which are connected to one another below the axial ball bearing 118.28 by means of another fastening screw 122.

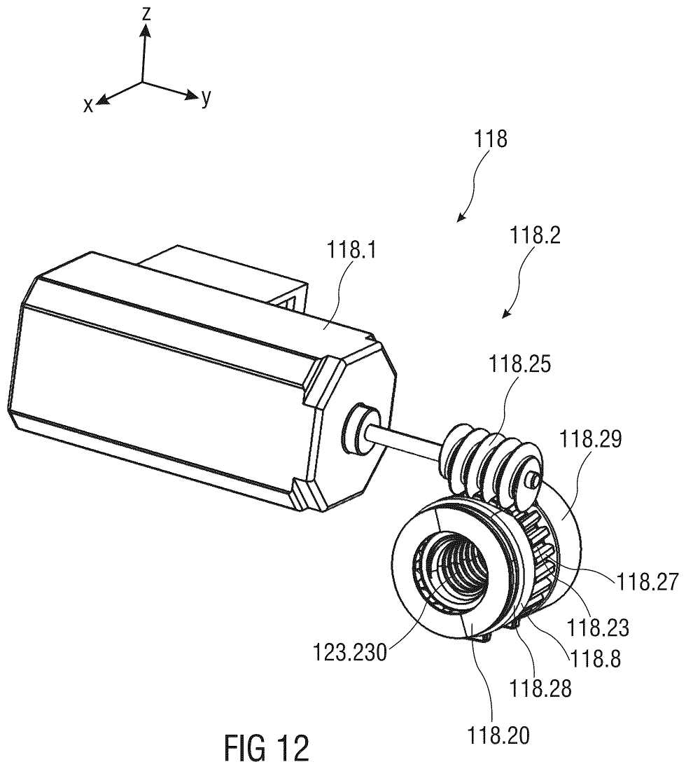

FIG. 12 shows a perspective illustration of the drive device 118 with the motor 118.1 and the gear unit 118.2 designed as a worm gear and having the drive worm 118.25, which is driven by the motor 118.1 and engages in the worm wheel 118.23, without the gear holder 118.21 and without the gear housing 118.22. On the one hand, the axial ball bearing 118.28 is arranged at one end of the worm wheel 118.23 and/or of the spindle nut 123.230, and, on the other hand, the axial bearing brush 118.29 is arranged at the other end thereof. The spring washer 118.20, in particular an annular spring washer, for the axially resilient support of the worm wheel 118.23 with the integrated spindle nut 123.230 in the gear housing 118.22 is arranged on the outside of the axial ball bearing 118.28, as described above. In addition, the radial bearing bush 118.8 is arranged between the worm wheel teeth 118.27 and the axial ball bearing 118.28.

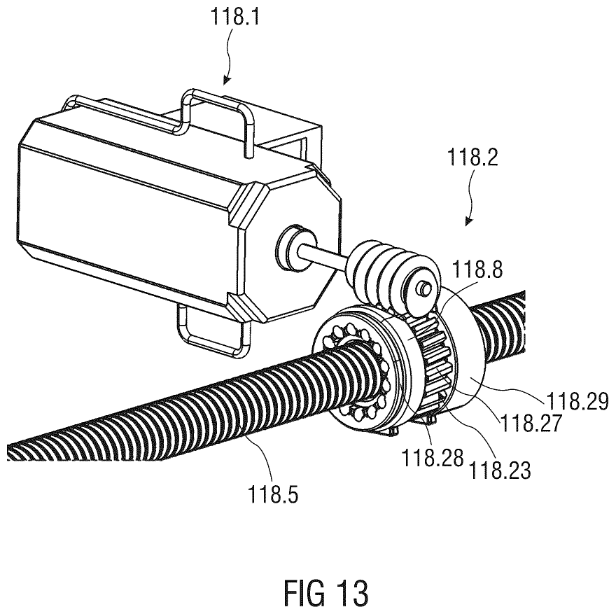

FIG. 13 shows FIG. 12 additionally with the spindle 118.5 arranged in a fixed manner in the gear unit 118.2.

FIG. 14 shows a perspective illustration of the worm wheel 118.23 with the integrated spindle nut 123.230 and with external worm wheel teeth 118.27 for engagement for the drive worm 118.25 and the internal trapezoidal thread 118.232 for engagement with the spindle 118.5, and the outer race surfaces 118.231 for sliding in the radial bearing bush 118.8 and in the axial bearing bush 118.29, and with the race surfaces 118.231 (also referred to as a running groove), running around the end face, for the balls 118.282 of the axial ball bearing 118.28 (illustrated in FIG. 13) in order to predetermine the running direction of the balls 118.282. The spring washer 118.20 alone cannot ensure this.

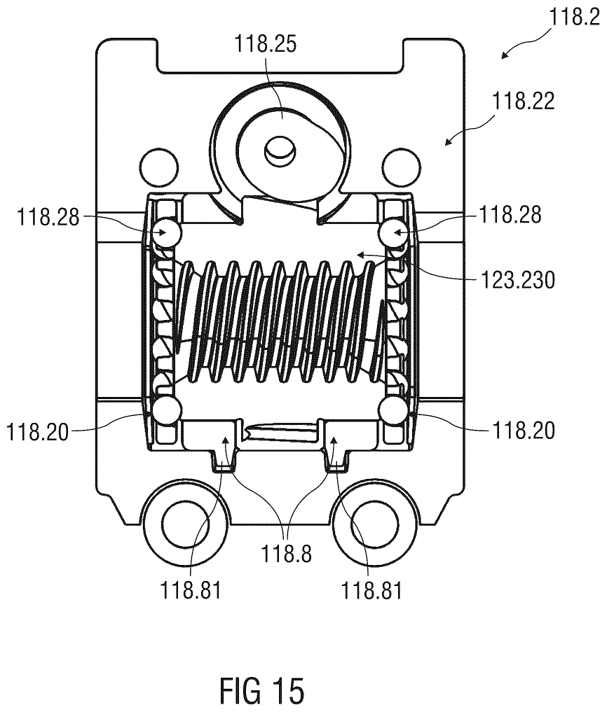

FIG. 15 shows a cut-open view of a gear housing 118.22 of a gear unit 118.2. FIG. 15 shows the gear housing 118.22 as an open housing with a top view of one of the housing shells, the drive worm 118.25 and the spindle nut 123.230 rotatably mounted in the gear housing 118.22 and driven by the drive worm 118.25.

The gear unit 118.2 of FIG. 15 differs from the gear unit 118.2 according to FIG. 6 in that it comprises two axial ball bearings 118.28 instead of one axial ball bearings 118.28 shown in FIG. 6.

The two axial ball bearings 118.28 are located on both sides of the spindle nut 123.230. Additionally, a spring washer 118.20 is arranged between the respective axial ball bearing 118.28 and the gear housing 118.22 on each side of the spindle nut 123.230.

Instead of the axial bearing bush 118.29 and the radial bearing bush 118.8 shown in FIG. 6, the design according to FIG. 15 comprises two radial bearing bushes 118.8 arranged between the spindle nut 123.230 and the gear housing 118.22. Each of the radial bearing bushes 118.8 comprises the radially projecting portion.

The structure and design of the axial ball bearings 118.28 and the spring washer 118.20 are the same as the parts described above and shown in FIG. 6.

### LIST OF REFERENCE SIGNS

100 vehicle seat
102 seat part
104 seat back
106 fitting
108 axis of rotation
110 longitudinal adjustment device
112 rail arrangement
114 first rail element (top rail)
114.1 rail aperture
116 second rail element (bottom rail)
118 drive device
118.1 motor
118.11 bearing interface
118.12 motor shaft
118.13 adapter
118.14 motor housing
118.2 gear unit
118.20 spring washer
118.201 external contact
118.202 internal contact
118.21 gear holder
118.211 clamp end
118.22 gear housing
118.220 rubber elements
118.221 housing recess
118.222 shaft bearing
118.223 housing shell
118.224 housing shell
118.23 worm wheel
123.230 spindle nut
118.231 race surface
118.232 trapezoidal thread
118.233 nut portions
118.24 latching nose
118.25 drive worm
118.26 worm teeth
118.27 worm wheel teeth
118.28 axial ball bearing
118.281 spring contact surface
118.282 balls
118.29 axial bearing bush
118.291 radial bearing portion
118.292 axial bearing portion
118.293 radially projecting portion
118.294 narrowing region
118.3 spindle bearing (first spindle bearing)
118.31 fastening leg
118.4 spindle bearing (second spindle bearing)
118.41 fastening surface
118.5 spindle
118.6 spindle thread
118.7 through openings
118.8 radial bearing bush
118.81 radially projecting portion
118.82 narrowing region
118.83 radial sliding bearing portion
118.9 anti-rotation safeguard
120 cavity
122 fastening screw
VI line
X longitudinal direction
y transverse direction
z vertical direction

What is claimed is:

1. A longitudinal adjustment device, comprising:
one rail arrangement, and
one drive device for the rail arrangement,
wherein the rail arrangement comprises a first rail, and a second rail guided movably on the first rail,
wherein the drive device comprises at least one motor, a gear unit supported in the second rail, a spindle with a spindle thread, and a spindle bearing,
wherein the gear unit comprises a drive worm drivable by the motor, and a worm wheel, which is in operative connection with the drive worm, and a spindle nut, which is in operative connection with the worm wheel,
wherein the spindle is of fixed design, is supported in the spindle bearing and is connected to the first rail,
wherein the drive worm, the worm wheel and the spindle nut are supported in a gear housing, and
wherein the worm wheel and/or the spindle nut are/is supported in the gear housing in an axially resilient manner and in the axial direction, on the one hand via at least one axial ball bearing and on the other hand via an axial bearing bush.

2. The longitudinal adjustment device as claimed in claim 1, wherein a spring washer is arranged between the gear housing and the axial ball bearing in the axial direction.

3. The longitudinal adjustment device as claimed in claim 2, wherein, in the axial direction, the spring washer on the one hand rests against the gear housing and on the other hand makes contact with a spring contact surface on the axial ball bearing.

4. The longitudinal adjustment device as claimed in claim 2, wherein the axial ball bearing is arranged between the spring washer and the spindle nut and/or the worm wheel in the axial direction.

5. The longitudinal adjustment device as claimed in claim 1, wherein, in the axial direction, the axial ball bearing on the one hand makes contact with the spring washer and on the other hand makes contact with a race surface on the spindle nut and/or on the worm wheel.

6. The longitudinal adjustment device as claimed in claim 1, wherein the axial bearing bush is designed as an angle bearing bush and has a cylindrical radial bearing portion and, adjoining the latter, an axial bearing portion in the form of an annular disk.

7. The longitudinal adjustment device as claimed in claim 1, wherein a radial bearing bush is arranged on an end region of the spindle nut which faces the axial ball bearing.

8. The longitudinal adjustment device as claimed in claim 7, wherein the radial bearing bush has a radially projecting portion for rotationally secure support in the gear housing.

9. The longitudinal adjustment device as claimed in claim 1, wherein the axial bearing bush has a radially projecting portion for rotationally secure support in the gear housing.

10. The longitudinal adjustment device as claimed in claim 1, wherein the motor comprises a motor shaft which extends into the gear housing and drives the drive worm arranged in the gear housing.

11. A vehicle seat having a longitudinal adjustment device as claimed in claim 1.
